(19) United States
(12) Patent Application Publication
(10) Pub. No.: US 2025/0063182 A1
(43) Pub. Date: Feb. 20, 2025

(54) TECHNIQUES FOR PROVIDING CHROMA FORMAT SCALABILITY IN IMAGE PROCESSING APPLICATIONS

(71) Applicant: APPLE INC., Cupertino, CA (US)

(72) Inventors: Alexandros TOURAPIS, Los Gatos, CA (US); Dimitri PODBORSKI, Cupertino, CA (US); Jungsun KIM, Sunnyvale, CA (US); Leo BARNES, Skane (SE); Davide CONCION, Campbell, CA (US)

(21) Appl. No.: 18/772,408

(22) Filed: Jul. 15, 2024

Related U.S. Application Data
(60) Provisional application No. 63/519,306, filed on Aug. 14, 2023.

(51) Int. Cl. H04N 19/30; H04N 19/186; H04N 19/59

(52) U.S. Cl. CPC H04N 19/30; H04N 19/186; H04N 19/59

(57) ABSTRACT

Techniques are disclosed for representing video and images with full resolution color component information and yet remain compatible with legacy processing systems that process images with reduced resolution information. The new image representation may include a scalable format that consists of a base layer, coded to match expectations of a legacy coder. The new image representation also may include additional enhancement layer(s) that enable upconversions of reduced-resolution color components to higher resolutions. The image representation not only provides power savings in decoding full-resolution representations but it also provides other benefits, such as scalable and power aware decoding.

### CLAIM FOR PRIORITY

The present application claims benefit from priority of U.S. application Ser. No. 63/519,306, entitled “Techniques For Providing Chroma Format Scalability In Image Processing Applications” and filed Aug. 14, 2023, the disclosure of which is incorporated herein in its entirety.

### BACKGROUND

The present disclosure relates to digital techniques for representing image information and, in particular, to techniques for multi-color image information.

In modern computing applications, there are a variety of ways to represent multi-color image information. In many cases, image information is represented by a variety of orthogonal color components, sometimes called “planes.” For example, a multi-color image may be represented by red, green, and blue color components in an “RGB” color space. In another example, the same multi-color image may be represented by a luma and two chroma color components, in a Y-Cr-Cb color space. Standards have been developed to govern representation of color in images, which facilitates image exchange in modern computing applications.

The 4:2:0 chroma format is currently the most popular chroma sampling format in consumer oriented video applications. In this format, each frame of a video sequence is represented with a luma component and two chroma components. The two chroma components, however, are represented using half the resolution vertically and horizontally compared to the luma component. This occurs because, for most content, the characteristics of the chroma signals permit a reduction in their resolution with limited impact in image quality. Such resolution reduction can help in reducing memory storage and bandwidth and provide some compressibility benefits when compressing the video sequence (e.g., the downscaling process can help in reducing some of the noise that may exist in the original 4:4:4 full resolution representation of each chroma component, making it easier to compress the chroma data). Alternative reduced resolution formats, such as the 4:2:2 format, also are known.

There are some applications where higher resolution of the chroma information is desirable, such as screen sharing, gaming, and still-image photography. Reducing chroma resolution compared to the luma resolution may result, in some cases, in artifacts around object edges/boundaries, especially if the edges have significant color differences (e.g. red object next to a blue background). Chroma subsampling can also exacerbate chroma leakage during compression. Chroma leakage, due to subsampling, can be especially visible in HDR content, where some techniques, such as the luma adjustment method for chroma conversion, have been proposed to keep such artifacts in check. Users often wish to maintain, e.g. for archiving purposes, the highest quality version of their content, which may include full resolution chroma samples, while distributing the lower resolution versions to others when needed.

Unfortunately, although a full resolution chroma feature is highly desirable, the majority of consumer-oriented devices currently deployed, such as set-top box decoders, mobile devices, computers, etc. can support only up to 4:2:0 chroma format hardware decoding. Although software decoding of natively coded 4:4:4 content is possible, such software applications could consume too much power in battery powered devices or might not be possible in real time coding applications involving certain resolutions and frame-rates.

### BRIEF DESCRIPTION OF THE DRAWINGS

FIG. 1 illustrates a coding system according to an embodiment of the present disclosure.

FIG. 2 illustrates an exemplary image according to an embodiment of the present disclosure.

FIG. 3 illustrates processing according to an embodiment of the present disclosure.

FIG. 4 illustrates process flow among the base layer image and enhancement layer images according to an embodiment of the present disclosure.

FIG. 5 illustrates an exemplary image file according to an embodiment of the present disclosure.

FIG. 6 illustrates an exemplary image file according to another embodiment of the present disclosure.

FIG. 7 illustrates an exemplary image file according to a further embodiment of the present disclosure.

FIG. 8 is a data flow diagram illustrating coding data flow among base layer and enhancement layer images according to an embodiment of the present disclosure.

FIG. 9 is a data flow diagram illustrating decoding data flow among base layer and enhancement layer images according to an embodiment of the present disclosure.

FIG. 10 illustrates a coding system according to another embodiment of the present disclosure.

FIG. 11 illustrates processing flow according to an embodiment of the present disclosure.

FIG. 12 illustrates process flow according to an embodiment of the present disclosure.

FIG. 13 illustrates a decoding system according to an embodiment of the present disclosure.

FIG. 14 illustrates a coding system according to another embodiment of the present disclosure.

### DETAILED DESCRIPTION

Embodiments of the present disclosure provide techniques for representing video and images with full resolution color component information and yet remaining compatible with legacy processing systems that process images with reduced resolution information, such as the 4:2:2 and/or 4:2:0 representations that are popular with luma-chroma image representations. The image representation may include a scalable format that consists of a base layer, where image data is coded to match expectations of a legacy coder. The image representation also may include additional enhancement layer(s) that support upconversions of reduced-resolution color components to higher resolutions. The image representation not only provides power savings in decoding full-resolution representations but it also provides other benefits, such as scalable and power aware decoding.

The following discussion presents the techniques proposed by the present disclosure in context of a system that codes images in a luma-chroma color plane. As discussed herein, luma-chroma representations of images and/or video (“images” for convenience) commonly are represented in a 4:2:0 format, where chroma image components are represented with reduced resolution as compared to the luma color component. The principles of the present disclosure, however, may be extended to other image formats, as may be desired, where one color component is represented in a reduced-resolution representation as compared to another color component. The use of luma-chroma examples within the following discussion should not be interpreted to limit application of the proposed techniques to any particular color space.

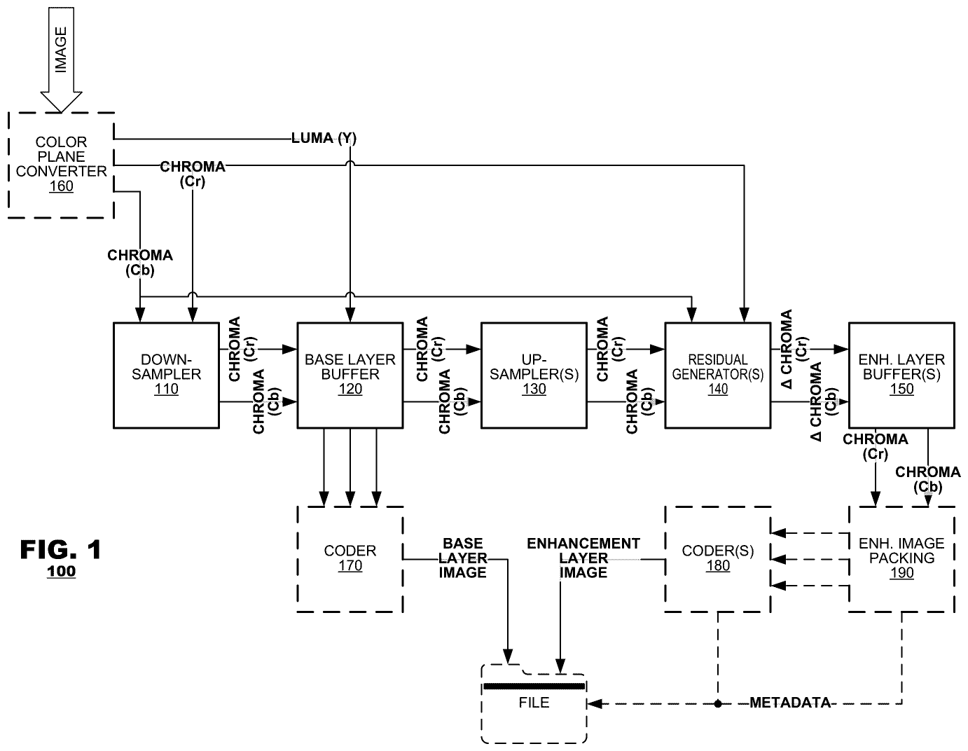

FIG. 1 illustrates a coding system 100 according to an embodiment of the present disclosure. The system 100 may include a downsampler 110, a base layer buffer 120, upsampler(s) 130, residual generator(s) 140, and enhancement layer buffer(s) 150. The system 100 may accept image data in a variety of color representations; for images received in a non-luma/chroma format, a color plane converter 160 may convert the images from their native format into the luma-chroma color format. Thus, in the present discussion, a source image is described as being input to the system 100 in a format in which the luma, Cr, and Cb color components have the same resolution as each other (even the source image is converted to this format at input).

The downsampler 110 may downsample resolution of the chroma color components to a lower resolution in conformance to the color format to which the base layer image adheres. Thus, in an implementation using a 4:2:2 format, the downsampler 110 may downsample the chroma color components (Cr, Cb) so that each has half the resolution in the horizontal direction as the corresponding luma color component. Similarly, in an implementation using a 4:2:0 format, the downsampler 110 may downsample the chroma color components (Cr, Cb) so that each has half the resolution in both the horizontal and vertical directions as the corresponding luma color component. The downsampler 110 may output downsampled Cr and Cb chroma data to the base layer buffer 120.

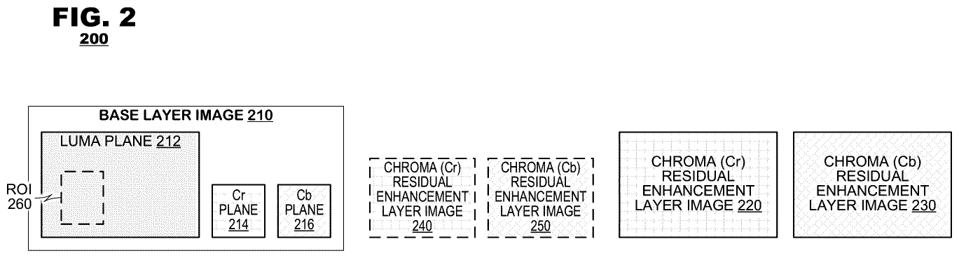

The base layer buffer 120 may store luma component data and downsampled chroma component data until it is to be transferred to a file. The data stored in the base layer buffer 120 may form a base layer image (FIG. 2) of the image to be generated by the system 100. Typically, the base layer data is compressed by a coder 170 before storage in the file. The compression may occur according to an interoperability coding standard such as ISO/ITU-T's HEVC/H.265 standard or AOMedia's Video 1 standard (commonly AV1). In such cases, the downsampling provided by the downsampler 110 may conform to the resolution of image data (e.g., 4:2:2, 4:2:0 or another resolution) that is appropriate for the coder 170 being used. In practice, the coder 170 may be a coding system provided by a processing device on which the system 100 operates.

The upsampler 130 may upsample downsampled chroma data from the base layer buffer 120 to a higher resolution. For example, the Cr and Cb chroma data may be upsampled from the 4:2:2 or 4:2:0 resolution as stored in the base layer buffer 120 to a full resolution format (e.g., 4:4:4). The upsampler 130 may operate according to a predefined upscaling technique such as lanczos 5, bilinear, bicubic, or some other upsampler. Alternatively, the system 100 may dynamically select parameters of the upsampler 130 and provide metadata in a file identifying the selected parameters. The upsampling techniques accounts for the chroma location type compared to that of the luma, i.e. whether the chroma location type is equal to 0, 1, 2 etc., which may impact the phase of the upscaler used.

The residual generator 140 may generate residual signals for the Cr and Cb chroma data based on comparisons between the upsampled Cr and Cb chroma signals and the source Cr and Cb chroma signals at the system's input. The Cr and Cb chroma residual signals may be input to enhancement layer buffer(s) 150. These Cr and Cb chroma residual signals may form the basis of enhancement layer image(s) for the source image.

FIG. 2 illustrates an exemplary image file 200 that may be generated by the system 100 of FIG. 1. The file is shown as including a base layer image 210 and one or more enhancement layer image(s) 220, 230. The base layer image 210 may include a luma plane 212 that possesses information corresponding to the luma component of the source image, a Cr plane 214 that possesses information corresponding to the downsampled Cr chroma component generated by the downsampler 110 (FIG. 1), and a Cb plane 216 that possesses information corresponding to the downsampled Cb chroma component of the source image. The luma 212 and Cr and Cb chroma 214, 216 components of the base layer image 210 may represent the source image in a reduced resolution representation such as 4:2:0.

The enhancement layer image(s) 220, 230 may include color residual(s) that possess information corresponding to one or more reduced-resolution color components 214, 216 from the base layer image 210 at a higher resolution. Continuing with the 4:2:0 example above, the Cr and Cb planes 214, 216 of the base layer image 210 may have half the resolution horizontally and vertically comparatively to the luma plane 212 of the base layer image 210. Cr and Cb chroma residual enhancement layer images 220, 230 may provide information corresponding to the Cr and Cb chroma residuals generated by the residual generator 140. The enhancement layer images 220, 230 may provide information from which full resolution Cr and Cb chroma residuals may be derived.

Two enhancement layer images 220, 230 are shown in the example of FIG. 2, one corresponding to each of the Cr and Cb chroma residuals generated by the residual generator 140. It is not required that two enhancement layer images 220, 230 be generated in all cases. The principles of the present disclosure find application with implementations that generate enhancement layer data for a single color component. It is expected that system designers will tailor application of the system 100 (FIG. 1) and the file formats (FIG. 2) of the present disclosure to suit their individual needs.

The principles of the present disclosure may be applied to provide multiple levels of scalability as may be desired. One such embodiment is illustrated in FIG. 2 in phantom, where an image 200 contains several Cr enhancement layer images 220, 240 and several Cb enhancement layer images 230, 250. It may be desired, for example, to provide image content in a base layer representation (say, 4:2:0), image content in an intermediate representation (say 4:2:2), and image content in a full resolution representation (say 4:4:4). In such an application, a first pair of residual enhancement layer image(s) 240, 250 may provide residual information of reduced resolution image data (Cr and Cb chroma, in this example) at the intermediate resolution representation. The first residual enhancement layer image(s) 240, 250 may be derived differentially from the base layer representation by a first set of residual generators 140 (FIG. 1). A second pair of residual enhancement layer image(s) 220, 230 may provide residual information of the reduced resolution image data (Cr and Cb chroma, in this example) at a next-higher resolution. The second residual enhancement layer image(s) 220, 230 may be derived differentially from the first residual enhancement layer image(s) 240, 250 by another set of residual generators (not shown in FIG. 1). These relationships among the base layer representations of reduced resolution color information and the increasingly higher resolution representations of the enhancement layer images may be repeated for as many resolutions as may be desired.

As a further example of multi-level scalability, one or more enhancement layer images may support increased resolution of regions of interest within image(s). A region of interest (also “ROI”) may be a spatial area of a source image that is determined to contain image data that likely is of interest to human viewers. The example of FIG. 2 identifies an exemplary region of interest 260 in the luma plane 212, which may relate to a corresponding location in a source image (not shown).

In such applications, a first layer of scalability may be provided by enhancement layer images 220, 230 that may provide enhancement information for the entire spatial area of a source image and a second layer of scalability may be provided by enhancement layer images 240, 250 that correspond to the spatial area of the region of interest 260. The enhancement layer images 220, 230 may provide enhancement information for the entire spatial area of the source image that, when decoded with content of the base layer 210, increases the resolution of the image so obtained (say, from a 4:2:0 format to a 4:2:2 format). The ROI enhancement layer images 240, 250 may provide enhancement information that, when decoded with content of the base layer image 210, increase resolution of the area corresponding to the region of interest 260 to a maximum resolution (e.g., from a 4:2:0 format to a 4:4:4 format). The ROI enhancement layer images 240, 250 may be coded differentially with respect to spatially coincident content of the enhancement layer images 220, 230, which themselves may be coded differentially with respect to the base layer image 210. In another implementation, the ROI enhancement layer images 240, 250 may be coded differentially directly from the base layer image 210 (e.g., without consideration of the enhancement layer images 220, 230).

The principles of the present disclosure find application in systems in which a base layer coder 180 supports monochrome coding such as by using the HEVC monochrome profiles or by using the HEVC Main/Main 10 profiles in which coding discards chroma planes. In such an application, the Cr and Cb chroma planes 214, 216 of the base layer image 210 would be empty. The Cr and Cb residual enhancement layer images 220, 230 would contain full resolution representations of the chroma information (e.g., they are not residuals).

The principles of the present disclosure also find applications in which Cr and Cb residual enhancement layers 220, 230 are not coded differentially with respect to upsampled Cr and Cb chroma information from the base layer image 210. For example, the upsampler(s) 130 and residual generator(s) 140 (FIG. 1) may be omitted, and the enhancement layer buffer(s) 150 may take their Cr and Cb chroma inputs from the source image or color plane converter 160, as the case may be. Such an implementation may lead to lower compression efficiency as compared to an implementation where Cr and Cb residual enhancement layers 220, 230 contain residual information, but they may benefit from reduced complexity at decode. Moreover, system implementations may toggle between codings in which the upsampler(s) 130 and residual generator(s) 140 are enabled and those in which the residual generator(s) 140 are disabled; a coding system 100 (FIG. 1) may provide metadata to identify the states of the residual generator(s) 140 for the codings.

In one embodiment, the image file 200 may be represented using the High Efficiency Image File (commonly, “HEIF”) format defined by MPEG, for example, in ISO/IEC 23008-12 (MPEG-H Part 12). In particular, an implementation may use the derived image item and the alternative group concepts in this format. The base layer image 210, for example, may be stored as a primary item in a HEIF file. The enhancement layer image(s) 220, 230, 240, 250 may be placed in an ‘altr’ alternative group, which indicates that the base layer image 210 (e.g., having a 4:2:0 format) and the enhancement layer image(s) 220, 230, 240, 250 are alternatives of each other.

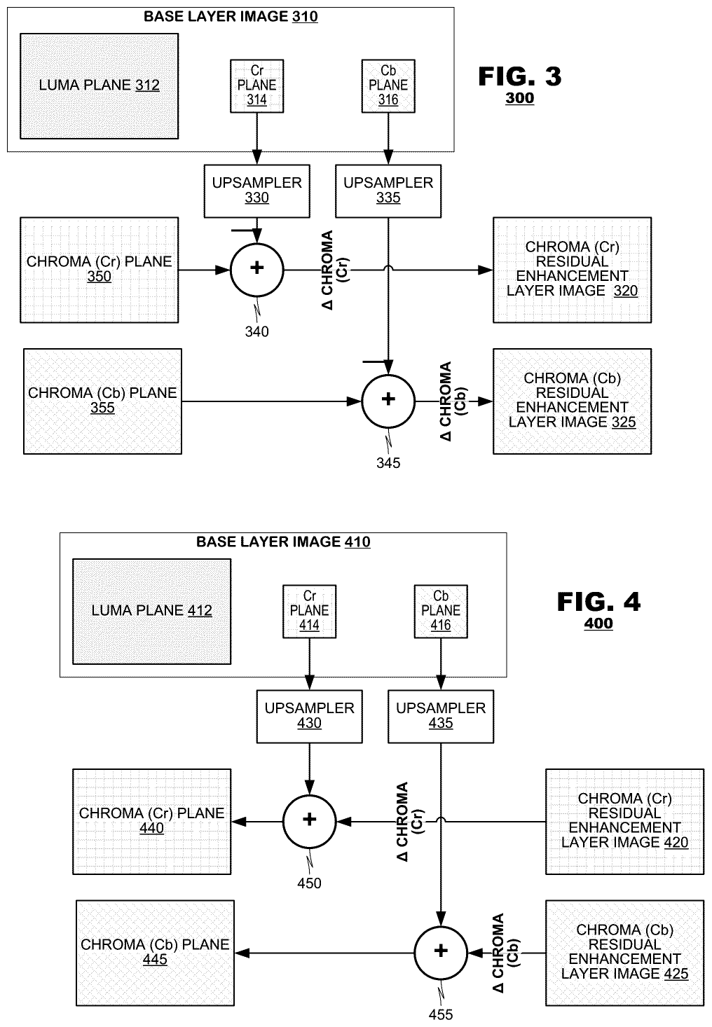

FIG. 3 illustrates processing flow 300 among components of a base layer image 310 and enhancement layer image(s) 320, 325 according to an embodiment of the present disclosure. FIG. 3 illustrates a process to generate the enhancement layer images 320, 325 from the base layer image components and source chroma data. As discussed, the base layer image 310 may contain a luma plane 312, a Cr plane 314 and a Cb plane 316, and the enhancement layer image 320, 325 may contain Cr and Cb chroma residuals, respectively. Respective upsamplers 330 and 335 may upsample component data from the Cr plane 314 and the Cb plane 318. A pair of comparators 340 and 345 may generate Cr and Cb chroma residual signals from the upsampled chroma data. Specifically, a first comparator 340 may compare the upsampled Cr chroma data generated by the upsampler 330 to the source Cr chroma data, and a second comparator 345 may compare the upsampled Cb chroma data generated by the upsampler 335 to the source Cb chroma data. These chroma residual signals may for the bases of the Cr and Cb chroma residuals in the enhancement layer image(s) 320, 325.

FIG. 4 illustrates process flow 400 among the base layer image 410 and enhancement layer image(s) 420, 425 according to an embodiment of the present disclosure. FIG. 4 illustrates a process to recover source chroma data from the base layer and enhancement layer images 410, 420. As discussed, the base layer image 410 may contain a luma plane 412, a Cr plane 414 and a Cb plane 416, and the enhancement layer images 420, 425 may contain Cr and Ch chroma residuals. Respective upsamplers 430 and 435 may upsample component data from the Cr plane 414 and the Cb plane 418. A pair of adders 440 and 445 may generate recovered Cr and Cb chroma signals 440, 412 from the upsampled Cr and Cb chroma data and the Cr and Cb chroma residuals 420, 425. Specifically, a first adder 440 may add the upsampled Cr chroma data generated by the upsampler 430 to the Cr chroma residual 420, and a second comparator 445 may add the upsampled Cb chroma data generated by the upsampler 435 to the Cb chroma residual 425. Thus, full resolution Cr and Cb chroma components may be recovered from the base layer and enhancement layer images 410, 420.

Returning to FIG. 1, enhancement layer data stored in the buffer 150 may be compressed by a coder 180, which may but need not operate according to the same coding protocol(s) as in the coder 170. For example, the base layer image may have been coded using the HEVC Main or Main 10 profile, or even the AV1 Main profile in 8 or 10 bits, and the enhancement layer image could use the AVC Progressive High profile, or only HEVC Main (in 8 bits), or even JPEG. Other codecs/coding specifications could be used. Metadata information may be signaled with the coded image that informs a decoder of how each layer is encoded and how each layer could be combined with the base layer.

In application, the enhancement layer image likely will contain mostly residual data commonly shifted to the center of the bitdepth representation, (i.e. if the coded representation is of 8 bits a value of 128 is added to the residual signals and clipped within 0 to 255) and, therefore, may be appropriate for the coder 180 to reduce the dynamic range of the signal and code it with a lower bitdepth. Different bitdepth could be used for the different layers, while also scaling of the samples may also be used to increase precision, and that could be different for each layer.

In an embodiment, the coder 180 may operate on the chroma component data after the component data is packed into a virtual image format by an enhancement image packing unit 190. The enhancement image packing unit 190 may arrange the Cr and Cb chroma component data into a format that presents the component data to the coder 180 as if it were luma data. The coder 180 may apply is coding protocols to the virtual image as presented by the enhancement image packing unit 190, which may lead to generation of a file that has an enhancement layer image in an alternate format. Two examples of the alternate formats are shown in FIGS. 3 and 4, respectively.

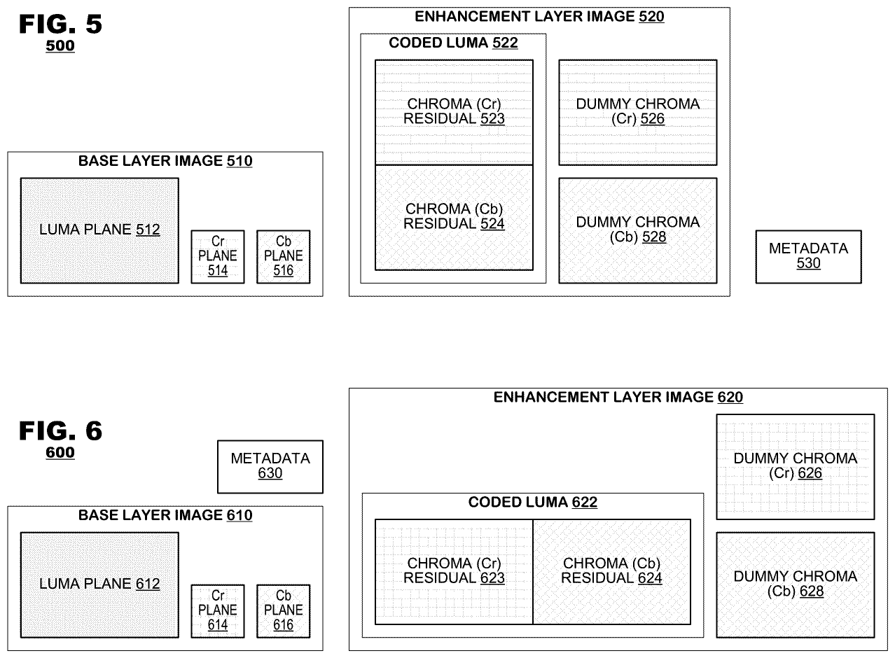

In the example of FIG. 5, the enhancement layer image 520 contains several elements: a coded luma element 522, a dummy Cr chroma element 526, and a dummy Cb chroma element 528. The coded luma element 522 may contain the Cr and Cb chroma residuals 523, 524 generated by the residual generator 140 (FIG. 1), which are packed into a virtual luma element and coded by the coder 180 to yield the luma element 522. In such an application, the coder 180 may apply its coding protocols to the Cr and Cb chroma residuals 523, 524 as if they constitute an image of luma information. In the example of FIG. 5, the Cr and Cb chroma residuals 523, 524 are stacked vertically with respect to each other; thus, the virtual luma element may have an image height that is twice the height of the content that makes up the luma plane 512.

In the FIG. 5 implementation, the dummy Cr and Cb chroma images 526, 528 may contain null data. It is expected that, when the dummy Cr and Cb chroma images 526, 528 are coded by the coder 180, they will have extremely small bit sizes.

A metadata field 530 may identify processing performed by the enhancement layer packing unit 190 and/or coder 180. For example, the metadata 530 may identify a packing relationship between the Cr and Cb chroma residuals 523, 524 within the virtual luma image. The metadata 530 also may identify a type of coding applied by the coder 180 in implementations where the system 100 may select dynamically a type of coding to be applied.

In the example of FIG. 6, the enhancement layer image 620 also contains a coded luma element 622, a dummy Cr chroma element 626, and a dummy Cb chroma element 628. The coded luma element 622 may contain the Cr and Cb chroma residuals 623, 624 generated by the residual generator 140 (FIG. 1), which are packed into a virtual luma element and coded by the coder 180 to yield the luma element 622. As in the FIG. 5 embodiment, the coder 180 may apply its coding protocols to the Cr and Cb chroma residuals 623, 624 of the FIG. 6 embodiment, as if they constitute an image of luma information. In the example of FIG. 6, the Cr and Cb chroma residuals 623, 624 are placed horizontally adjacent to each other; thus, the luma element may have an image width that is twice the width of the content that makes up the luma plane 612.

A metadata field 630 may identify processing performed by the enhancement layer packing unit 190 and/or coder 180. For example, the metadata 630 may identify a packing relationship between the Cr and Cb chroma residuals 623, 624 within the virtual luma image (e.g., their horizontal placement with respect to each other). The metadata 630 also may identify a type of coding applied by the coder 180 in implementations where the system 100 may select dynamically a type of coding to be applied.

In the FIG. 6 implementation, the dummy Cr and Cb chroma images 626, 628 may contain null data. It is expected that, when the dummy Cr and Cb chroma images 626, 628 are coded by the coder 180, they will have extremely small bit sizes.

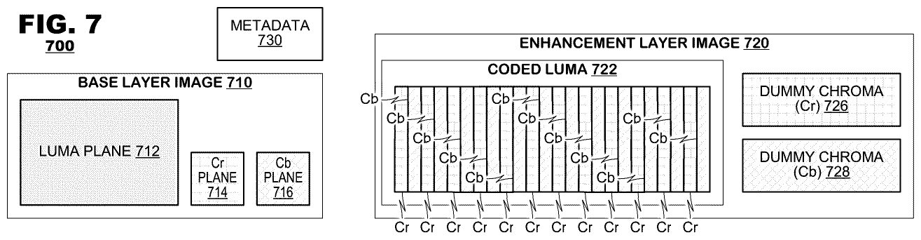

FIG. 7 illustrates another packing relationship that may be developed by the enhancement packing unit 190 (FIG. 1). In this example, a virtual luma element may be developed by a spatial interleaving of the Cr and Cb chroma residuals developed by the residual generators 140 (FIG. 1). In an aspect, the spatial elements may be selected to match a spatial granularity that is used by the coder 180 (FIG. 1) when the virtual luma element is coded. For example, Cr and Cb chroma residuals may be interleaved at a superblock granularity, a coding unit granularity, or other granularity that contributes to efficient coding by the coder 180.

A metadata field 730 may identify processing performed by the enhancement layer packing unit 190 and/or coder 180. For example, the metadata 730 may identify a packing relationship between the Cr and Cb chroma residuals 723, 724 within the virtual luma image (e.g., their interleaved relationship respect to each other and the granularity at which they were selected). The metadata 730 also may identify a type of coding applied by the coder 180 in implementations where the system 100 may select dynamically a type of coding to be applied.

As in the other embodiments, the dummy Cr and Cb chroma images 726, 728 may contain null data. It is expected that, when the dummy Cr and Cb chroma images 726, 728 are coded by the coder 180, they will have extremely small bit sizes.

FIG. 8 is a data flow diagram illustrating data flow among base layer and enhancement layer images 810, 820, 830 according to an embodiment of the present disclosure. In this embodiment, the base layer image 810 contains a luma plane 812, a Cr chroma plane 814, and a Cb chroma plane 816 arranged in a legacy representation such as 4:2:0 or 4:2:2. A first Cr enhancement layer image 820 may contain a virtual luma plane 822, a virtual Cr chroma plane 824, and a virtual Cb chroma plane 826. A second Cb enhancement layer image 830 may contain a virtual luma plane 832, a virtual Cr chroma plane 834, and a virtual Cb chroma plane 836. Each of the base layer image 810, the Cr enhancement layer image 820, and the Cr enhancement layer image 830 may be coded by respective coders 840, 850, 860.

In the example of FIG. 8, Cr chroma data of a source image (not shown) is packed into the luma plane 822 of the Cr enhancement layer image 820. Virtual Cr and Cb chroma fields 824, 826 of the Cr enhancement layer image 820 may contain dummy data. The Cr enhancement layer image 820 may be presented to a first enhancement layer encoder 850 in a legacy representation (e.g., 4:2:0 or 4:2:2), which allows the Cr enhancement layer image 820 to be coded by a legacy coder of a conventional consumer electronics device.

Similarly, Cb chroma data of a source image (also not shown) may be packed into the luma plane 832 of the Cb enhancement layer image 830. Virtual Cr and Cb chroma fields 834, 836 of the Cb enhancement layer image 830 may contain dummy data. The Cb enhancement layer image 830 may be presented to a second enhancement layer encoder 860 in a legacy representation (e.g., 4:2:0 or 4:2:2), which allows the Cb enhancement layer image 830 to be coded by a legacy coder of a conventional consumer electronics device.

FIG. 8 also shows a multiplexer 870 which may organize coded data from the coders 840, 850, 860 according to requirements of a file storage protocol such as HEIF.

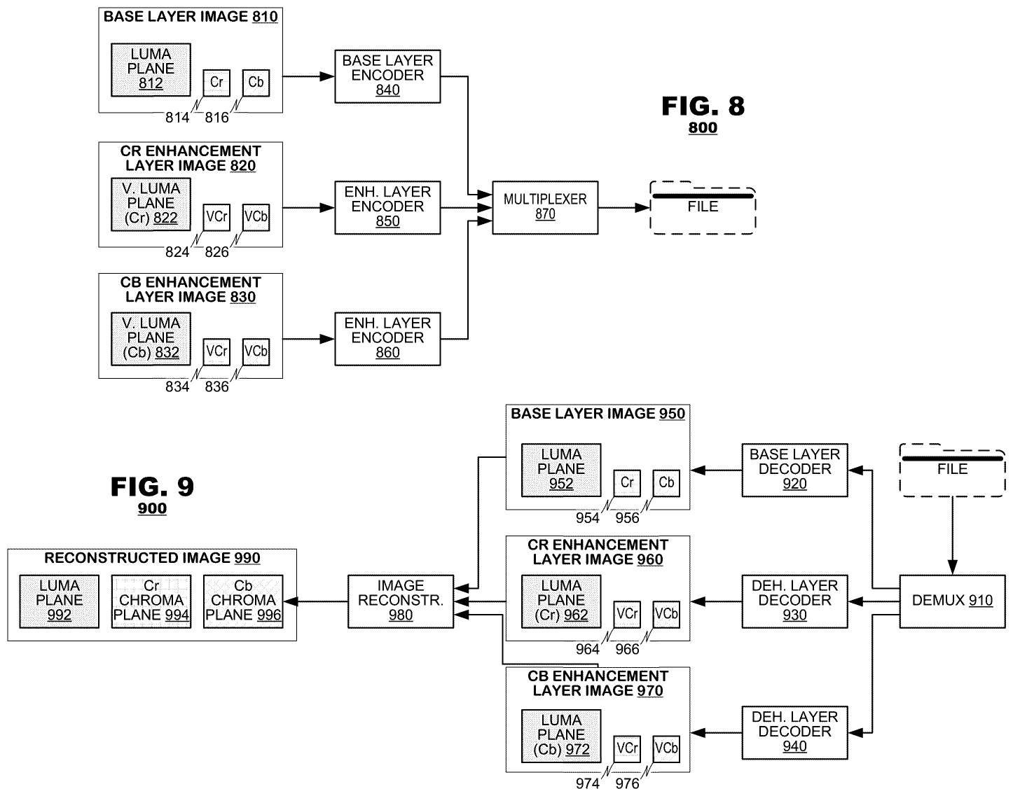

FIG. 9 is a data flow diagram illustrating a decode process for base layer and enhancement layer images created by the data flow of FIG. 8. In this embodiment, a demultiplexer 910 may parse data from the file into coded components representing coded base layer images and enhancement layer images and forward those components to respective decoders 920, 930, and 940. A base layer decoder 920 may invert coding processes performed by a base layer encoder 840 (FIG. 8) and generate a recovered base layer image 950 therefrom. The base layer decoder 950 may operate according to legacy decoding processes in which case it may yield a decoded image 950 in a legacy representation such as 4:2:0 or 4:2:2.

A first enhancement layer decoder 930 may invert coding processes performed by a first enhancement layer encoder 850 (FIG. 8) and generate a recovered Cr enhancement layer image 960 therefrom. The first enhancement layer decoder 930 also may operate according to legacy decoding processes in which case it may yield a decoded image 960 in a legacy representation such as 4:2:0 or 4:2:2. As the Cr enhancement layer image 820 (FIG. 8) contained Cr chroma data of a source image packed into a virtual luma plane 822 of the Cr enhancement layer image 820, the recovered Cr enhancement layer image 960 also may contain recovered Cr chroma data packed into the virtual luma plane 962 of the Cr enhancement layer image 960. The virtual Cr and Cb chroma planes 964, 966 of the Cr enhancement layer image 960 may contain dummy data.

A second enhancement layer decoder 940 may invert coding processes performed by a second enhancement layer encoder 860 (FIG. 8) and generate a recovered Cb enhancement layer image 970 therefrom. The second enhancement layer decoder 940 also may operate according to legacy decoding processes in which case it may yield a decoded image 970 in a legacy representation such as 4:2:0 or 4:2:2. As the Ch enhancement layer image 830 (FIG. 8) contained Cb chroma data of a source image packed into a virtual luma plane 832 of the Cb enhancement layer image 83, the recovered Cb enhancement layer image 970 also may contain recovered Cb chroma data packed into the virtual luma plane 972 of the Ch enhancement layer image 970. The virtual Cr and Cb chroma planes 974, 976 of the Ch enhancement layer image 970 may contain dummy data.

An image reconstructor 980 may generate a reconstructed image 990 from the recovered base layer and enhancement layer images 950, 960, 970. As discussed, virtual luma planes 962, 972 of the Cr and Cb enhancement layer images 960, 970 may contain recovered Cr and Cb chroma data, respectively. The data in those luma planes 962, 972 may represent the Cr and Cb components at full resolution (e.g., matching the resolution of the luma data contained within the luma plane 952 of the recovered base layer image 950). The image reconstructor may derive a reconstructed image 990 at full resolution (e.g., 4:4:4) from the full resolution luma representation contained within the luma plane 952 of the base layer image 950, the full resolution Cr chroma representation contained within the luma plane 962 of the first enhancement layer image 960, and the Cb chroma representation contained within the luma plane 972 of the second enhancement layer image 970. Of course, in processing applications for which lower resolution image information is suitable (e.g., a recovered 4:2:0 representation of the source image suffices), a decoder may decode the base layer image 950 without processing of any coded enhancement layer image from the file.

The data flow diagrams of FIGS. 8 and 9 illustrate coding examples in which the Cr and Cb chroma information of the enhancement layer images 820, 830 (FIG. 8) and 960, 970 (FIG. 9) are not developed differentially with respect to the Cr and Cb chroma information 814, 816 of the base layer image 810.

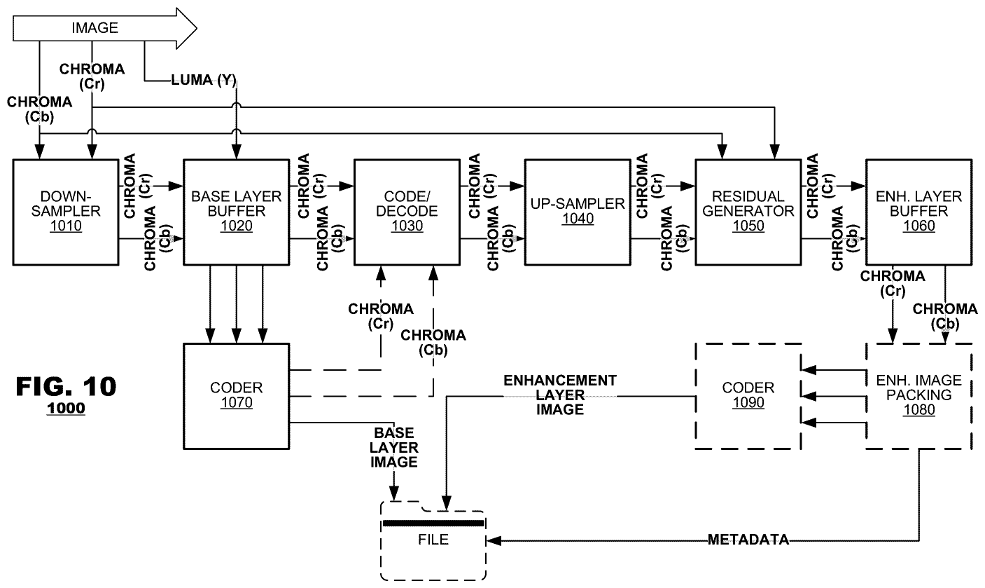

FIG. 10 illustrates a coding system 1000 according to another embodiment of the present disclosure. The system 1000 may include a downsampler 1010, a base layer buffer 1020, coder(s)/decoder(s) 1030, upsampler(s) 1040, residual generator(s) 1050, enhancement layer buffer(s) 1060, and a coder 1070. As in the FIG. 1 embodiment, the system 1000 may accept image data in a variety of color representations; for images received in a non-luma/chroma format, they may be converted into the luma/chroma color format. Thus, the system 1000 is shown as processing a source image in which the luma, Cr, and Cb color components have the same resolution as each other.

The downsampler 1010 may downsample resolution of the chroma color components to a lower resolution in conformance to the color format to which the base layer image adheres. Thus, in an implementation using a 4:2:2 format, the downsampler 1010 may downsample the chroma color components (Cr, Cb) so that each has half the resolution in the horizontal direction as the corresponding luma color component. Similarly, in an implementation using a 4:2:0 format, the downsampler 1010 may downsample the chroma color components (Cr, Cb) so that each has half the resolution in both the horizontal and vertical directions as the corresponding luma color component. The downsampler 1010 may output downsampled Cr and Cb chroma data to the base layer buffer 1020.

The base layer buffer 1020 may store luma component data and downsampled chroma component data until it is to be transferred to a file. The data stored in the base layer buffer 1020 may form a base layer image (FIG. 2) of the image to be generated by the system 1000. In this embodiment, the base layer data is compressed by the coder 1070 before storage in the file. The compression may occur according to an interoperability coding standard such as HEVC or AV1. In such cases, the downsampling provided by the downsampler 1010 may conform to the resolution of image data (e.g., 4:2:2, 4:2:0 or another resolution) that is appropriate for the coder 1070 being used. In practice, the coder 1070 may be a coding system provided by a processing device on which the system 1000 operates.

The coder/decoder 1030 may code the downsampled Cr and Cb chroma signals according to the coding algorithm applied by the coder 1070 and decode the coded signals. Many coding algorithms are lossy coding processes, which cause signals to incur coding losses as they are coded and decoded. Thus, the coder/decoder 1030 may output Cr and Cb chroma signals that represent the Cr and Cb chroma signals that are input to the coder/decoded 1030 but exhibit some coding errors. The coding errors introduced by the coder/decoder 1030 are likely to resemble coding errors that are incurred by a decoding system (not shown) when the image file is decoded.

The upsampler 1040 may upsample downsampled Cr and Cb chroma signals input to it from the coder/decoder 1030 to a higher resolution. For example, the Cr and Cb chroma data may be upsampled from the 4:2:2 or 4:2:0 resolution as present in the base layer buffer 1020 to a full resolution format (e.g., 4:4:4). Again, the upsampler 1040 may operate according to a predefined upscaling technique such as lanczos 5, bilinear, bicubic, or some other upsampler. The upsampling techniques account for the chroma location type compared to that of the luma, i.e. whether the chroma location type is equal to 0, 1, 2 etc., which can impact the phase of the upscaler used.

The residual generator 1050 may generate residual signals for the Cr and Cb chroma data based on comparisons between the upsampled Cr and Cb chroma signals and the source Cr and Cb chroma signals at the system's input. The Cr and Cb chroma residual signals may be input to respective enhancement layer buffers 1060. These Cr and Cb chroma residual signals may form the basis of the enhancement layer images for the source image.

Enhancement layer data stored in the enhancement layer buffer 1060 may be compressed by a coder 1090, which may (but need not) operate according to the same coding protocol(s) as in the coder 1070. The coder 1090 may operate directly on the Cr and Cb chroma components in which case the enhancement layer image 220 (FIG. 2) may have objects for the Cr and Cb planes 214, 216 as illustrated in FIG. 2. Alternatively, the coder 1090 may operate as discussed with respect to any of FIGS. 5-7 using virtual images generated by the enhancement layer packing unit 1080.

In an alternate embodiment, the coder/decoder 1030 may be implemented solely as a decoder that inverts coding operations performed by the coder 1070. In such an embodiment, coded Cr and Cb chroma data may be input to the decoder 1030 from the coder 1070 (path shown in phantom).

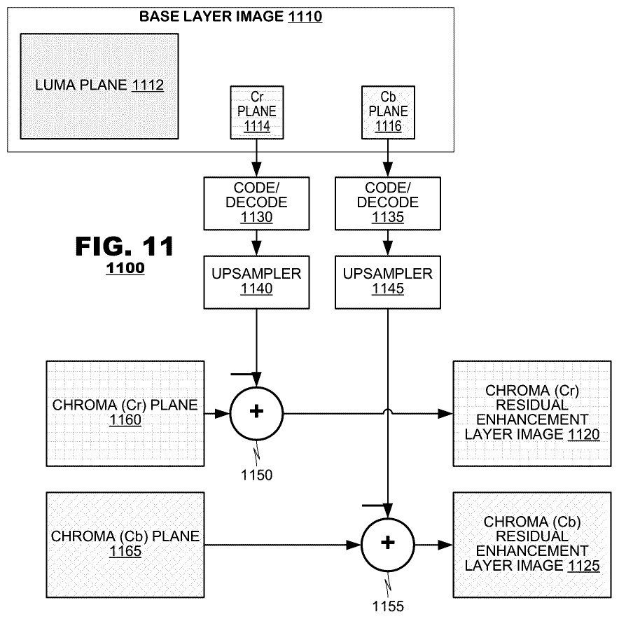

FIG. 11 illustrates processing flow 1100 among components of a base layer image 1110 and enhancement layer image(s) 1120, 1125 according to an embodiment of the present disclosure. FIG. 11 illustrates a process to generate enhancement layer images 1120, 1125 from the base layer image components and source chroma data. As discussed, the base layer image 1110 may contain a luma plane 1112, a Cr plane 1114 and a Cb plane 1116, a first enhancement layer image 1120 may contain a Cr chroma residual, and a second enhancement layer image 1125 may contain a Cb chroma residual. Respective coder/decoder units 1130, 1135 may code then decode the Cr and Cb chroma signals 1114, 1116 from the base layer image 1110. Respective upsamplers 1140 and 1145 may upsample decoded component data from the Cr plane 1114 and the Cb plane 1118. A pair of comparators 1150 and 1155 may generate Cr and Cb chroma residual signals from the upsampled chroma data. Specifically, a first comparator 1150 may compare the upsampled Cr chroma data generated by the upsampler 1140 to the source Cr chroma data, and a second comparator 1155 may compare the upsampled Cb chroma data generated by the upsampler 1145 to the source Cb chroma data. These chroma residual signals may form the bases of the Cr and Cb chroma residual enhancement layer images 1120, 1125.

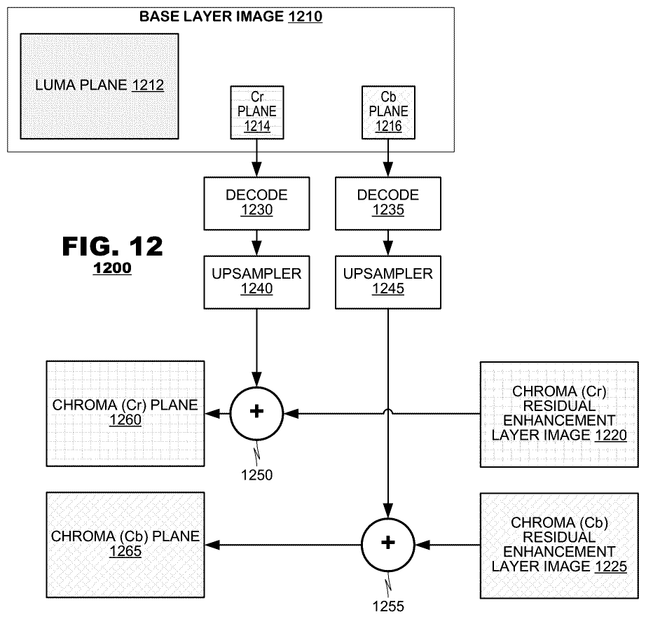

FIG. 12 illustrates process flow 1200 among the base layer image 1210 and enhancement layer image(s) 1220, 1225 according to an embodiment of the present disclosure. FIG. 12 illustrates a process to recover source chroma data from the base layer and enhancement layer images 1210, 1220, 1225. As discussed, the base layer image 1210 may contain a luma plane 1212, a Cr plane 1214 and a Cb plane 1216, the first enhancement layer image 1220 may contain a Cr chroma residual and the second enhancement layer image 1225 may contain a Cb chroma residual. Respective decoders 1230, 1235 may decode the Cr and Cb chroma signals 1214, 1216 from the base layer image 1210. Respective upsamplers 1240 and 1245 may upsample the decoded Cr and Cb chroma data from the decoders 1230, 1235. A pair of adders 1250 and 1255 may generate recovered Cr and Cb chroma signals 1260, 1265 from the upsampled Cr and Cb chroma data and the Cr and Cb chroma residuals 1220, 1225. Specifically, a first adder 1250 may add the upsampled Cr chroma data generated by the upsampler 1240 to the Cr chroma residual 1220, and a second comparator 1255 may add the upsampled Cb chroma data generated by the upsampler 1245 to the Cb chroma residual 1225. Thus, full resolution Cr and Cb chroma components may be recovered from the base layer and enhancement layer images 1210, 1220, 1225.

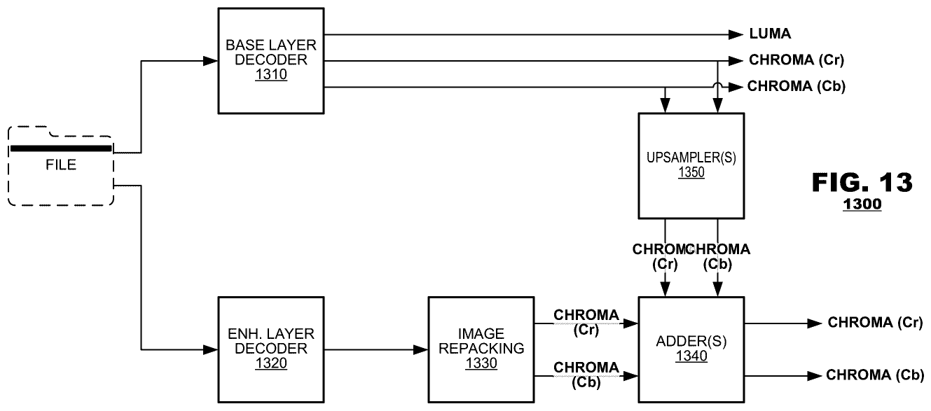

FIG. 13 illustrates a decoding system 1300 for generating recovered images with full-resolution chroma according to an embodiment of the present disclosure. The system 1300 may include a base layer decoder 1310 which may decode base layer images (FIGS. 2, 5-7) by inverting coding processes applied by the coders (FIGS. 1, 10) of the systems that created it. Thus, for base layer images coded according to HEVC techniques, the base layer image may be decoded also according to HEVC techniques. And, for base layer images coded according to AV1 techniques, the base layer image may be decoded according to AV1 techniques. The base layer decoder 1310 may output recovered luma, Cr chroma, and Cb chroma data. The recovered image data output by the base layer decoder 1310 may have reduced resolution Cr and Cb chroma as compared to the source image (FIGS. 1, 10) from which it is generated. For example, the recovered image data from the base layer decoder 1310 may have a 4:2:2 or 4:2:0 format as appropriate for the base layer decoder 1310.

The system 1300 also may include enhancement layer decoder 1320, an image repacking unit 1330, adders 1340, and upsamplers 1350 for processing of enhancement layer images (FIGS. 2, 5-7). The enhancement layer decoder 1320 may decode the enhancement layer image to invert any processing techniques that were performed by enhancement image coder such as the coder 180 of FIG. 1 or the coder 1090 of FIG. 10. The image repacking unit 1330 may reformat decoded data output from the enhancement layer decoder 1320 to invert formatting operations performed by enhanced image packing units 190 (FIG. 1) or 1080 (FIG. 10). Thus, in implementations where virtual luma images were formed from Cr and Cb chroma residuals and coded, such as shown in the examples of FIGS. 5-7, the image repacking units 1330 may reformat the virtual luma image into Cr and Cb chroma residuals.

The upsamplers 1350 may perform upsampling operations on the Cr and Cb chroma signals output from the base layer decoder 1310. The upsampling operations may mimic the upsampling operations performed by the upsamplers shown in FIGS. 1, 3-4, and/or 10. As a result of the upsampling operations, the Cr and Cb chroma signals output from the base layer decoder 1310 may be converted to the higher resolution at which the Cr and Cb residual signals from the enhancement layer decoder 1320 are represented. The adders 1340 may generate full resolution recovered Cr and Cb chroma signals from the upsampled Cr and Cb chroma signals from the upsamplers 1350 and the Cr and Cb residual signals from the enhancement layer decoder 1320. As a result, the system 1300 may output the luma signal from the base layer decoder 1310 and the recovered Cr and Cb chroma signals from the adders as a full resolution representation of the source image from which the file was generated. Thus, where a base layer image may represent a source image in a 4:2:2 or 4:2:0 format, the system 1300 may output the recovered image in a 4:4:4 format when using the full resolution Cr or Cb chroma data as recovered by the adders 1340. Data flow for the system 1300 may progress as shown, for example, in FIG. 4 or 12.

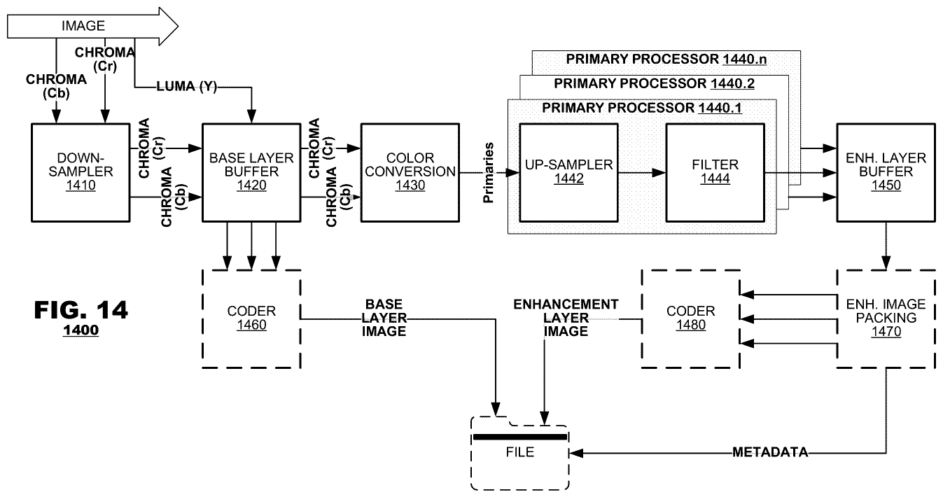

FIG. 14 illustrates a coding system 1400 according to another embodiment of the present disclosure. The system 1400 may include a downsampler 1410, a base layer buffer 1420, a color converter 1430, one or more component processors 1440.1-1440.n, an enhancement layer buffer 1450, and a base layer coder 1460. As in the FIG. 1 embodiment, the system 1400 may accept image data in a variety of color representations; for images received in a non-luma/chroma format, they may be converted into the luma/chroma color format. Thus, the system 1400 is shown as processing a source image in which the luma, Cr, and Cb color components have the same resolution as each other.

The downsampler 1410 may downsample resolution of the chroma color components to a lower resolution in conformance to the color format to which the base layer image adheres. Thus, in an implementation using a 4:2:2 format, the downsampler 1410 may downsample the chroma color components (Cr, Cb) so that each has half the resolution in the horizontal direction as the corresponding luma color component. Similarly, in an implementation using a 4:2:0 format, the downsampler 1410 may downsample the chroma color components (Cr, Cb) so that each has half the resolution in both the horizontal and vertical directions as the corresponding luma color component. The downsampler 1410 may output downsampled Cr and Cb chroma data to the base layer buffer 1420.

The base layer buffer 1420 may store luma component data and downsampled chroma component data until it is to be transferred to a file. The data stored in the base layer buffer 1420 may form a base layer image (FIG. 2) of the image to be generated by the system 1400. In this embodiment, the base layer data is compressed by the coder 1470

The coder 1460 may code the luma data and downsampled Cr and Cb chroma data before the system 1400 stores the base layer image in the file. As in the prior embodiments, the compression may occur according to an interoperability coding standard such as HEVC or AV1. In such cases, the downsampling provided by the downsampler 1410 may conform to the resolution of image data (e.g., 4:2:2, 4:2:0 or another resolution) that is appropriate for the coder 1470 being used. In practice, the coder 1460 may be a coding system provided by a processing device on which the system 1400 operates.

The color converter 1430 may convert the source luma component and the downsampled Cr and Cb chroma components from a luma/chroma color space to an alternate color space such as a red/green/blue color space or a Y′UV color space. Other representations, e.g. a different RGB representation with different color primaries and a different transfer characteristics (e.g. from YCbCr BT.709 to RGB BT.2100 PQ) could be used. The color converter 1430 may output component data to the component processors 1440.1-1440.n. When the color converter 1430 has capability to convert input image data to multiple color spaces, the color converter 1430 may output metadata identifying a selected color space.

The system 1400 may have a plurality of component processors 1440.1-1440.n one provided for each color component of the color space to which the color converter 1430 converts its input data. Each component processor 1440.1, . . . , 1440.n may possess an upsampler 1442 and a filter system 1444. As in the prior embodiments, the upsampler 1442 may upsample its respective color component to a full resolution of the source image. The upsampler 1440 may upsample downsampled Cr and Cb chroma signals input to it from the coder/decoder 1430 to a higher resolution. For example, the Cr and Cb chroma data may be upsampled from the 4:2:2 or 4:2:0 resolution as present in the base layer buffer 1420 to a full resolution format (e.g., 4:4:4). The filter system 1444 may apply filtering operations to the upsampled color component. Filtered output from the filters 1444 may be stored in the enhancement layer buffer 1450 and may form the basis of the enhancement layer image.

The system 1400 also may possess an image packing unit 1470 that arranges the component data stored in the enhancement layer buffer 1450 into a virtual image, which may be coded by a coder 1480. As in the prior embodiments, the coder 1480 may (but need not) operate according to a different compression standard than that of the coder 1460.

In an embodiment, the system 1400 also may include a coder/decoder (not shown) as described in the FIG. 10 embodiment. In this implementation, the coder/decoder may operate on data from the base layer buffer 1420 prior to being input to the color converter 1430.

Because the embodiment of FIG. 14 converts the enhancement color information to an alternate color space, the Cr and Cb components are likely to provide a contribution to each component of the alternate color space. In such applications, it is possible for a decoder (not shown) to select, based on its local computing resources, which decoding layers to decode. For example, in some cases a decoder may select to only decode the base layer and skip decoding all of the enhancement layers (e.g. a user is viewing an image and scrolling or zooming very fast) or only decode one component from the enhancement layer instead of all components.

In the foregoing embodiments, base layer images and enhancement layer images may be stored in container formats such a HEIF container. With a HEIF containers, in order to be backwards compatible and allow older players to render a “traditional” 4:2:0 image, the base layer image (e.g., a 4:2:0 image) may be stored as a primary item in a HEIF file and enhancement layer image(s) may be stored in alternative groups. Alternatively, both image items (base and enhancement layer images) may be placed in an ‘altr’ alternative groups, which may indicate that the images are alternatives of each other. Placing the base layer image as the first image in the altr group and enhancement layer image(s) as secondary images may facilitate backwards compatibility with decoders that are not programmed to recognize the enhancement layer image(s) because decoders typically are programmed to ignore data representations that they do not recognize. Systems, however, that are programmed to understand the enhancement layer image(s) can access, decode, and display the larger resolution (e.g., 4:4:4).

In another embodiment, a system according to the foregoing embodiments may cascade operations, generating a succession of enhancement layer images. For example, an ‘altr’ group can have an image at 4:4:4 resolution, another image at 4:2:2 resolution, and a further image at 4:2:0 resolution. In a cascaded operation, the 4:4:4 version may be derived from the 4:2:2 version, and the 4:2:2 version may be derived from the 4:2:0 version. In the context of the FIG. 1 embodiment, a first stage of upsamplers 130 may be programmed to upscale input image data to an intermediate resolution (e.g., from 4:2:0 to 4:2:2) and a second stage of upsamplers (not shown) may upscale data stored in the enhancement layer buffer 150 (e.g., from 4:2:2 to 4:4:4). A second sequence of upsamplers, residual generators, and enhancement layer buffers (not shown in FIG. 1) may be provided for this purpose.

In a further embodiment, other features, such as HDR could be included. For example, an ‘altr’ group can have 4:4:4 HDR, 4:2:0 HDR, and 4:2:0 SDR (primary), or be a 4:4:4 HDR, 4:4:4 SDR, and 4:2:0 SDR. In the first case, the HDR enhancement image is derived first followed by the 4:4:4 generation, while in the second case the 4:4:4 SDR enhancement image is derived first and the HDR one is derived thereafter. Close loop conversions for all these cases can be employed at the encoder end for improved performance.

The foregoing discussion has described the various embodiments of the present disclosure in the context of coding systems, decoding systems and process flows that they employ. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. In some applications, the functional blocks described hereinabove may be provided as elements of an integrated software system, in which the blocks may be provided as elements of a computer program, which are stored as program instructions in memory and executed by a general processing system. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, the functional blocks described herein need not be provided as separate elements. For example, although FIGS. 1-14 illustrate components of video coders and decoders as separate units, in one or more embodiments, some or all of them may be integrated and they need not be separate units. Such implementation details are immaterial to the operation of the present invention unless otherwise noted above.

Further, the figures illustrated herein have provided only so much detail as necessary to present the subject matter of the present invention. In practice, video coders and decoders typically will include functional units in addition to those described herein, including buffers to store data throughout the coding pipelines illustrated and communication transceivers to manage communication with the communication network and the counterpart coder/decoder device. Such elements have been omitted from the foregoing discussion for clarity.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A coding method, comprising:
coding a multi-color source image in a scalable coding representation comprising:
a base layer image containing coded representations of each of a plurality of color components, at least a first color component having a reduced resolution as compared to a resolution of a second color component,
an enhancement layer image containing a coded representation of the first color component at a resolution that is increased with respect to the reduced resolution of the first color component.

2. The method of claim 1, wherein the coded representation of the first color component is at a resolution that matches the resolution of the second color component in the base layer image.

3. The method of claim 1, wherein the coded representation of the first color component is at a resolution that is intermediate between the resolution of the second color component in the base layer image and the reduced resolution of the first color component in the base layer image.

4. The method of claim 1, wherein the coded representation of the first color component in the enhancement layer is coded differentially with respect to the coded representations in the base layer image.

5. The method of claim 1, wherein the coded representation of the of the first color component in the enhancement layer image both are derived from the source image non-differentially with respect to the first color component in the base layer image.

6. The method of claim 1, further comprising a second enhancement layer image containing a coded representation of the first color component at an intermediate resolution between the resolution of the first color component in the base layer image and the resolution of the first color component in the first enhancement layer image.

7. The method of claim 1, further comprising a second enhancement layer image containing a coded representation of the first color component at a spatial location corresponding to a region of interest in the source image.

8. The method of claim 1, further comprising forming the enhancement layer image by:
upsampling the first color component from the reduced resolution of the base layer image,
generating residuals from a comparison between the upsampled first color component of the base layer image to a resolution of the source image.

9. The method of claim 7, further comprising, prior to the upsampling, coding then deciding the reduced resolution first color component data by a compression technique that matches a compression technique to code the base layer image.

10. The method of claim 1, further comprising forming the enhancement layer image by:
converting the first color component from a color space of the source image to an alternative color space,
coding the converted color component data in the enhancement layer image.

11. The method of claim 5, further comprising bandwidth compressing the residuals.

12. The method of claim 1, wherein:
the coded representation of the base layer image is formed from a bandwidth compression of the base layer image color components, and
the coded representation of the enhancement layer image is formed from a bandwidth compression of the enhancement layer image color components.

13. The method of claim 10, wherein the bandwidth compression of the base layer image color components and the bandwidth compression of the enhancement layer image color components are performed according to a same operability standard.

14. The method of claim 1, wherein the base layer image and the enhancement layer image each are represented in respective HEIF alternative groups.

15. The method of claim 1, wherein the first and second color components are members of a luma-chroma color space.

16. The method of claim 1, wherein the base layer image represents the source image in a 4:2:0 format.

17. The method of claim 1, wherein the base layer image represents the source image in a 4:2:2 format.

18. The method of claim 1, wherein the base layer image and the enhancement layer image represent the source image in a 4:4:4 format.

19. A coding method, comprising:
coding a multi-color source image in a scalable coding representation comprising:
a base layer image containing coded representations of each of a plurality of color components, first and second color component each having a reduced resolution as compared to a resolution of a third color component,
an enhancement layer image containing a coded representation of the first and second color components at a resolution that is increased with respect to the reduced resolution of the base layer image.

20. The method of claim 17, further comprising forming the enhancement layer image by:
upsampling a reduced resolution representation of the first color component from the base layer image,
generating first color component residuals from a comparison between the upsampled first color component of the base layer image to a resolution of the source image.
upsampling a reduced resolution representation of the second color component from the base layer image,
generating second color component residuals from a comparison between the upsampled second color component of the base layer image to a resolution of the source image; and
forming a virtual image from a spatial merger of the first color component residuals and the second color component residuals, and
coding the virtual image as the enhancement layer image.

21. The method of claim 18, wherein the forming places the first color component residuals and the second color component residuals adjacent to each other horizontally.

22. The method of claim 18, wherein the forming places the first color component residuals and the second color component residuals adjacent to each other vertically.

23. The method of claim 18, wherein the forming spatially interleaves the first color component residuals and the second color component residuals.

24. A coding method, comprising:
coding a multi-color source image in a scalable coding representation comprising:
a base layer image containing a coded representation of a first color component of the source image according to a monochrome coding algorithm,
an enhancement layer image containing a coded representation of a different second color component of the source image,
wherein the base layer image and the enhancement layer image, when decoded, provide recovered source image data in which the first and second color components have a common resolution.

25. A decoding method, comprising:
responsive to a determination that a recovered image is to be obtained at a base level of resolution, decoding a base layer image to obtain the recovered image, the base layer image containing coded representations of each of a plurality of color components of a source image, at least a first color component having a reduced resolution as compared to a resolution of a second color component,
responsive to a determination that the recovered image is to be obtained at an enhanced level of resolution:
decoding the base layer image containing the coded representations of each of the plurality of color components of a source image,
decoding an enhancement layer image containing a coded representation of the first color component at a resolution that is increased with respect to the reduced resolution of the first color component to obtain residuals of the first color component, and
merging the decoded base layer image and enhancement layer images to obtain the recovered image.

26. A coder comprising:
a base layer coder having inputs for color component data representing a source image,
an enhancement layer coding system comprising:
an upsampler having an input for data corresponding to a first color component at a resolution corresponding to the color component's base layer resolution and an output for upsampled first color component data, and
a residual generator having a first input coupled to the upsampler output, a second input for first color component data from the source image, and an output for residual first color component data.

27. The coder of claim 24, further comprising a coder/decoder having an input for data corresponding to a first color component at a resolution corresponding to the color component's base layer resolution and an output coupled to the upsampler input.

28. The coder of claim 24, further comprising a second upsampler and second residual generator for data of a second color component.

29. The coder of claim 26, further comprising a virtual image generator having inputs coupled to outputs of the residual generators for the first and second color components.
